(19) United States
(12) Patent Application Publication
(10) Pub. No.: US 2023/0319243 A1
(43) Pub. Date: Oct. 5, 2023

(54) A multi-directional pattern projector and a hyper-resolution pattern projector

(71) Applicant: ARC-Y-TEC LTD., Netanya (IL)

(72) Inventors: Yohan Yehouda COHEN, Tsufim (IL); Yuval INBAR, Ein Shemer (IL); Elad LEVY, Nir Tzvi (IL); Amit LEVY, Matan (IL)

(21) Appl. No.: 18/043,338

(22) PCT Filed: Aug. 17, 2021
(86) PCT No.: PCT/IL2021/050996

§ 371 Date: Feb. 28, 2023

Related U.S. Application Data
(60) Provisional application No. 63/072,263, filed on Aug. 31, 2020.

(51) Int. Cl. H04N 9/31

(52) U.S. Cl. CPC H04N 9/3147; H04N 9/3161

(57) ABSTRACT

A multi-directional projector includes: a laser source capable of emitting laser beams, a reflective surface capable of reflecting the laser beams emitted by the laser source, wherein the reflective surface is movable by a movement mechanism, for causing the laser beams to reflect to a plurality of directions, a plurality of optical elements, each capable of directing incoming laser beams of the laser beams, being the laser beams directed by the reflective surface when moved by the movement mechanism at the direction of the respective optical element, to a respective projection direction with respect to the laser source, wherein at least two of the optical elements direct the respective incoming laser beams in different projection directions having at least a 90 degrees difference.

### TECHNICAL FIELD

The invention relates to a multi-directional hyper-resolution pattern projector.

### BACKGROUND

In stereoscopic or structured light imaging systems, pattern (e.g. dot) projection systems often employ lenses, Diffractive Optical Element (DOE) and a single or an array of vertical-cavity surface-emitting laser (VCSEL) or edge-emitting laser units. Light from the VCSEL/edge-emitting laser is first collimated by a lens system, and then replicated by a two-dimensional grating into a large angular range (i.e. the pattern projector emits a predetermined light pattern onto a three-dimensionally shaped surface). The light pattern is captured by one or more stereo cameras (e.g. a pair of stereo infrared cameras) and analyzed for calculating depth, motion, etc.

In a stationary imaging system, in order to cover a large Field-of-View (FoV) (for example: 360° around a sensor containing the projector), multiple laser sources are required, so that each laser source can be directed to project in a specific distinct direction, thereby covering together the entire FoV. Such configuration can be energy consuming and may not meet eye-safety requirements.

Moreover, the pattern projector should match the FOV of the cameras, and the projected pattern is optimized to the cameras' resolution. In order to provide higher resolution (i.e. project larger number of dots onto a scene of interest) multiple laser sources are required.

Therefore, there is a growing need to provide a new system and method for multi-directional hyper-resolution pattern projector.

References considered to be relevant as background to the presently disclosed subject matter are listed below. Acknowledgement of the references herein is not to be inferred as meaning that these are in any way relevant to the patentability of the presently disclosed subject matter.

US Patent Application No. US20190202686A1 published on Jul. 4, 2019 discloses a semiconductor device package, which includes a carrier, a first reflective element, a second reflective element, a first optical component, a second optical component and a microelectromechanical system (MEMS) device. The carrier has a first surface. The first reflective element is disposed on the first surface of the carrier. The second reflective element disposed on the first surface of the carrier. The first optical component is disposed on the first reflective element. The second optical component is disposed on the second reflective element. The MEMS device is disposed on the first surface of the carrier to provide light beams to the first reflective element and the second reflective element. The light beams provided to the first reflective element are reflected to the first optical component and the light beams provided to the second reflective element are reflected to the second optical component.

US Patent Application No. US20190364226A1 published on Nov. 28, 2019 discloses a dot projector comprising a movable base, a light source emitter disposed above the movable base, a collimator, located in a front side of the light source emitter, a diffractive optical element (DOE) located in the front side of the light source emitter, and an actuator is connected to the movable base, the tilt angle of the movable base can be changed by providing a signal to the actuator.

U.S. Pat. No. 9,826,216B1 published on Nov. 21, 2017 discloses a pattern projection system includes a coherent light source, a repositionable DOE disposed to receive coherent light from said coherent light source and disposed to output at least one pattern of projectable light onto a scene to be imaged by an (x,y) two-dimensional optical acquisition system. Coherent light speckle artifacts in the projected pattern are reduced by rapidly controllably repositioning the DOE or the entire pattern projection system. Different projectable patterns are selected from a set of M patterns that are related to each other by a translation and/or rotation operation in two-dimensional cosine space. A resultant (x, y, z) depth map has improved quality and robustness due to projection of the selected patterns. Three-dimensional (x,y,z) depth data obtained from two-dimensional imaged data including despeckling is higher quality data than if projected patterns without despeckling were used.

U.S. Pat. No. 9,325,973B1 published on Apr. 26, 2016 discloses a dynamic projection of at least first and second patterns contributes detectable disparity onto a scene that includes a target object. The scene is imaged with two-dimensional cameras whose acquired imagery includes disparity contributions whose presence enable a three-dimensional reconstruction depth map to be rapidly and accurately generated. In one embodiment coherent light is input to a first DOE within whose near range output is disposed a second DOE, whose far range output projects an image. Electronically varying effective optical distance between the two DOEs varies the pattern projected from the second DOE. A processor system and algorithms enable dynamic intelligent selection of projected patterns to more readily discern target object characteristics: shape, size, velocity. Patterns can implement spatio-temporal depth reconstruction, spatio-temporal depth reconstruction, and even single-camera spatio-temporal light coding reconstruction. Target objects may be scanned or may make gestures that are rapidly detected and recognized by the system and method.

### General Description

In accordance with a first aspect of the presently disclosed subject matter, there is provided a multi-directional projector comprising: a laser source capable of emitting laser beams; a reflective surface capable of reflecting the laser beams emitted by the laser source, wherein the reflective surface is movable by a movement mechanism, for causing the laser beams to reflect to a plurality of directions; a plurality of optical elements, each capable of directing incoming laser beams of the laser beams, being the laser beams directed by the reflective surface when moved by the movement mechanism at the direction of the respective optical element, to a respective projection direction with respect to the laser source, wherein at least two given optical elements of the optical elements are capable of directing the respective incoming laser beams in different projection directions so that at least part of a field of illumination of one of the given optical elements covers an area located more than 90 degrees with respect to a projection direction of a center of projection of one of the given optical elements.

In some cases, the movement mechanism is a Microelectromechanical system (MEMS), or a mechanism including at least one of: a piezo-electric actuator, an electro-mechanical actuator, or a linear voice coil actuator.

In some cases, the MEMS is a quasi-static MEMS or a resonant MEMS.

In some cases, the MEMS is a single-axis MEMS or a dual-axis MEMS.

In some cases, the optical elements are pattern Diffractive Optical Elements (DOEs) and/or diffusers and/or Micro Lens Arrays (MLAs).

In some cases, a pattern of the pattern DOEs is selected from a group of: a dot pattern, a line pattern, or a polygonal pattern.

In some cases, the multi-directional projector further comprises one or more prisms, designed to redirect the laser beam perpendicularly to a respective optical element.

In some cases, the multi-directional projector further comprises one or more lenses, each positioned on an optical path of a respective laser beam directed at a respective optical element.

In some cases, the at least two of the optical elements direct the respective incoming laser beams in different projection directions having a 180 degrees difference.

In some cases, each of the optical elements cause scattering of the respective incoming laser beams, so that the scattering caused by a first optical element of the optical elements at least partially overlaps the scattering caused by a second optical element of the optical elements.

In some cases, the multi-directional projector further comprises one or more reflective elements, each positioned on an optical path of a respective laser beam redirecting the respective laser beam at a respective optical element.

In some cases, the movement mechanism is capable of causing the reflective surface (a) to tilt and/or (b) to move along an optical axis of the laser source.

In some cases, the multi-directional projector further comprises a repositioning component configured to cause the reflective surface to return to a known position upon deactivation of the movement mechanism.

In some cases, the multi-directional projector further comprises a controller configured to cause activation of the laser source in synchronicity with positions of the reflective surface so that the laser beams generated by the laser source are reflected by the reflective surface in a direction of the respective optical elements.

In some cases, the multi-directional projector further comprises a position sensor capable of determining the positions of the reflective surface.

In accordance with a second aspect of the presently disclosed subject matter, there is provided a multi-directional projector comprising: a laser source capable of emitting laser beams; one or more multi-mode optical path controlling elements, each having at least two operation modes including (a) a first operation mode in which the multi-mode optical path controlling element reflects the laser beams directed thereon, and (b) a second operation mode in which the multi-mode optical path controlling element enables passage of the laser beams directed thereon; a plurality of optical elements, each capable of directing incoming laser beams of the laser beams to a respective projection direction with respect to the laser source, wherein the incoming laser beams are (a) reflected by one or more of the multi-mode optical path controlling elements operating in the first operation mode, or (b) passed through one or more of the multi-mode optical path controlling elements operating in the second operation mode; and a controller capable of selectively changing an optical path of the laser beams over time by changing the operation modes of one or more of the multi-mode optical path controlling elements.

In some cases, at least one of the multi-mode optical path controlling elements has a third operation mode in which the multi-mode optical path controlling element enables passage of a first subset of the laser beams and reflection of a second subset of the laser beams, other than the first subset.

In some cases, the third operation mode is a selective mode enabling selectively determining a proportion between the first subset and the second subset.

In some cases, at least one of the multi-mode optical path controlling elements is a switchable mirror element.

In some cases, the optical elements are pattern Diffractive Optical Elements (DOEs) and/or diffusers and/or Micro Lens Arrays (MLAs).

In some cases, a pattern of the pattern DOEs is selected from a group of: a dot pattern, a line pattern, or a polygonal pattern.

In some cases, the multi-directional projector further comprises one or more prisms, designed to redirect the laser beam perpendicularly to a respective optical element.

In some cases, the multi-directional projector further comprises one or more lenses, each positioned on an optical path of a respective laser beam directed at a respective optical element.

In some cases, each of the optical elements cause scattering of the respective incoming laser beams, so that the scattering caused by a first optical element of the optical elements at least partially overlaps the scattering caused by a second optical element of the optical elements.

In some cases, the multi-directional projector further comprises one or more reflective elements, each positioned on the optical path of a respective laser beam redirecting the respective laser beam at a respective optical element.

In some cases, the controller is further configured to cause activation of the laser source in synchronicity with a desired setup of the operational modes of the multi-mode optical path controlling elements.

In accordance with a third aspect of the presently disclosed subject matter, there is provided a hyper-resolution pattern projector comprising: a laser source capable of emitting laser beams; a Diffractive Optical Element (DOE) capable of directly or indirectly projecting the laser beams in a fixed pattern onto a scene; a movement mechanism capable of rotating and/or tilting the DOE; and a controller configured to: activate the laser source to emit a first set of the laser beams, thereby projecting a first pattern being the fixed pattern onto first locations on the scene; activate the movement mechanism to rotate and/or tilt the DOE; and reactivate the laser source to emit a second set of the laser beams, thereby projecting a second pattern being the fixed pattern onto second locations on the scene, wherein the first pattern and the second pattern are identical.

In some cases, there is provided a system comprising: the hyper-resolution pattern projector; an image acquisition device; and a processing circuitry configured to: activate the image acquisition device to acquire images of the first pattern and the second pattern; generate a hyper resolution pattern image comprising the first pattern and the second pattern; and analyze the hyper resolution pattern image to determine a location of at least one object within the scene.

In some cases, the movement mechanism is an electro-mechanical actuator, a piezoelectric actuator, a linear voice coil motor actuator, or a Microelectromechanical (MEM) actuator.

In some cases, the hyper-resolution pattern projector further comprises a repositioning component configured to cause the DOE to return to a known position upon deactivation of the movement mechanism.

In some cases, the hyper-resolution pattern projector further comprises a position sensor capable of determining the positions of the DOE, wherein the reactivation of the laser source is performed based on a position reading of the DOE obtained from the position sensor.

In some cases, the hyper-resolution pattern projector further comprises one or more lenses, each positioned on an optical path of the laser beams directed at the DOE.

In accordance with a fourth aspect of the presently disclosed subject matter, there is provided a hyper-resolution pattern projector comprising: a laser source capable of emitting laser beams; an optical element capable of directly or indirectly projecting the laser beams in a fixed pattern; a mask capable of blocking at least part of the pattern; a movement mechanism capable of moving the mask in at least one degree of freedom; and a controller configured to: activate the laser source to emit a first set of the laser beams, thereby projecting a first sub-pattern of the fixed pattern onto a scene; activate the movement mechanism to move the mask; and reactivate the laser source to emit a second set of the laser beams, thereby projecting a second sub-pattern of the fixed pattern onto the scene, wherein the first sub-pattern and the second sub-pattern are not identical.

In some cases, there is provided a system comprising: the hyper-resolution pattern projector; an image acquisition device; and a processing circuitry configured to: activate the image acquisition device to acquire images of the first sub-pattern and the second sub-pattern;

generate a hyper resolution pattern image comprising the first sub-pattern and the second sub-pattern; and analyze the hyper resolution pattern image to determine a location of at least one object within the scene.

In some cases, the optical element is a Diffractive Optical Element (DOE) or a Micro Lens Array (MLA).

In some cases, the mask is designed to redirect the laser beams directed at the blocked part of the pattern to a non-blocked part of the pattern.

In some cases, the movement mechanism is a micro-electromechanical system (MEMS) or a mechanism including at least one of: a piezo-electric actuator, an electro-mechanical actuator, or a linear voice coil motor actuator.

In some cases, the MEMS is a quasi-static MEMS or a resonant MEMS.

In some cases, the MEMS is a single-axis MEMS or a dual-axis MEMS.

In some cases, the hyper-resolution pattern projector further comprises a repositioning component configured to cause the mask to return to a known position upon deactivation of the movement mechanism.

In some cases, the hyper-resolution pattern projector further comprises a position sensor capable of determining the positions of the mask, wherein the reactivation of the laser source is performed based on a position reading of the mask obtained from the position sensor.

In some cases, (a) the fixed pattern is homogeneous, (b) the first sub-pattern is non-homogeneous, and (c) the second sub-pattern is non-homogeneous.

In some cases, the at least one degree of freedom is selected from a group consisting of: tilting, rotating, translating, or any combination thereof.

In some cases, the hyper-resolution pattern projector further comprises one or more lenses, each positioned on an optical path of the laser beams directed at the optical element.

### BRIEF DESCRIPTION OF THE DRAWINGS

In order to understand the presently disclosed subject matter and to see how it may be carried out in practice, the subject matter will now be described, by way of non-limiting examples only, with reference to the accompanying drawings, in which:

FIG. 1 depicts schematic illustration of one example of a multi-directional projector in accordance with the presently disclosed subject matter;

FIG. 2 depicts schematic illustration of another example of a multi-directional projector in accordance with the presently disclosed subject matter;

FIG. 3 depicts schematic illustration of one example of a hyper-resolution pattern projector in accordance with the presently disclosed subject matter;

FIGS. 4A-4C depict schematic illustration of one example of projected patterns in accordance with the presently disclosed subject matter;

FIG. 5 depicts schematic illustration of another example of a hyper-resolution pattern projector in accordance with the presently disclosed subject matter; and

FIGS. 6A-6D depict schematic illustration of another example of projected patterns in accordance with the presently disclosed subject matter.

### DETAILED DESCRIPTION

In the following detailed description, numerous specific details are set forth in order to provide a thorough understanding of the presently disclosed subject matter. However, it will be understood by those skilled in the art that the presently disclosed subject matter may be practiced without these specific details. In other instances, well-known methods, procedures, and components have not been described in detail so as not to obscure the presently disclosed subject matter.

In the drawings and descriptions set forth, identical reference numerals indicate those components that are common to different embodiments or configurations.

Unless specifically stated otherwise, as apparent from the following discussions, it is appreciated that throughout the specification discussions utilizing terms such as “analyzing”, “changing”, “activating”, “reactivating”, “generating”, “determining”, “causing”, “projecting” or the like, include action and/or processes of a computer that manipulate and/or transform data into other data, said data represented as physical quantities, e.g. such as electronic quantities, and/or said data representing the physical objects. The terms “computer”, “processor”, “processing resource”, “processing circuitry” and “controller” should be expansively construed to cover any kind of electronic device with data processing capabilities, including, by way of non-limiting example, a personal desktop/laptop computer, a server, a computing system, a communication device, a smartphone, a tablet computer, a smart television, a processor (e.g. digital signal processor (DSP), a microcontroller, a field programmable gate array (FPGA), an application specific integrated circuit (ASIC), etc.), a group of multiple physical machines sharing performance of various tasks, virtual servers co-residing on a single physical machine, any other electronic computing device, and/or any combination thereof.

The operations in accordance with the teachings herein may be performed by a computer specially constructed for the desired purposes or by a general-purpose computer specially configured for the desired purpose by a computer program stored in a non-transitory computer readable storage medium. The term “non-transitory” is used herein to exclude transitory, propagating signals, but to otherwise include any volatile or non-volatile computer memory technology suitable to the application.

As used herein, the phrase “for example,” “such as”, “for instance” and variants thereof describe non-limiting embodiments of the presently disclosed subject matter. Reference in the specification to “one case”, “some cases”, “other cases” or variants thereof means that a particular feature, structure or characteristic described in connection with the embodiment(s) is included in at least one embodiment of the presently disclosed subject matter. Thus, the appearance of the phrase “one case”, “some cases”, “other cases” or variants thereof does not necessarily refer to the same embodiment(s).

It is appreciated that, unless specifically stated otherwise, certain features of the presently disclosed subject matter, which are, for clarity, described in the context of separate embodiments, may also be provided in combination in a single embodiment. Conversely, various features of the presently disclosed subject matter, which are, for brevity, described in the context of a single embodiment, may also be provided separately or in any suitable sub-combination.

Any reference in the specification to a method should be applied mutatis mutandis to a system capable of executing the method and should be applied mutatis mutandis to a non-transitory computer readable medium that stores instructions that once executed by a computer result in the execution of the method.

Any reference in the specification to a system should be applied mutatis mutandis to a method that may be executed by the system and should be applied mutatis mutandis to a non-transitory computer readable medium that stores instructions that may be executed by the system.

Any reference in the specification to a non-transitory computer readable medium should be applied mutatis mutandis to a system capable of executing the instructions stored in the non-transitory computer readable medium and should be applied mutatis mutandis to method that may be executed by a computer that reads the instructions stored in the non-transitory computer readable medium.

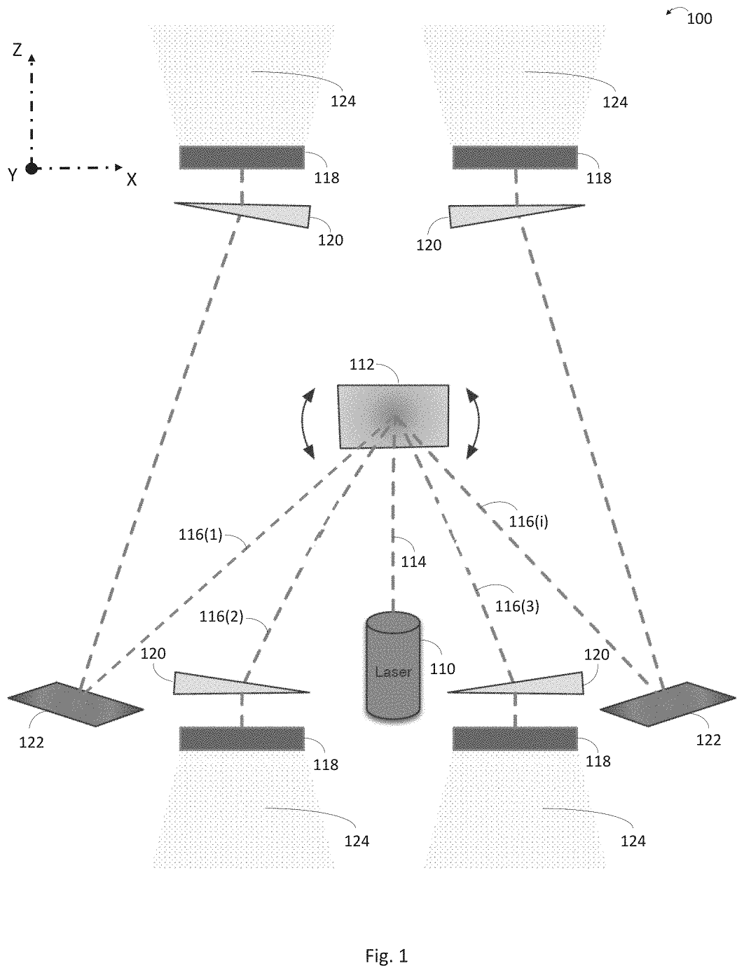

Bearing this in mind, attention is drawn to FIG. 1, showing a schematic illustration of one example of a multi-directional projector 100, in accordance with the presently disclosed subject matter.

The multi-directional projector 100 includes a laser source 110, a reflective surface 112, a movement mechanism (not shown in the figures) and a plurality of optical elements 118.

As shown in FIG. 1, the laser 110 (e.g. vertical-cavity surface-emitting laser (VCSEL), edge-emitting laser or the like) can be configured to emit laser beams 114 towards the reflective surface 112 that can be configured to deflect the laser beams 114 to varying optical scanning angles. This can be achieved by coupling the reflective surface 112 to a movement mechanism (not shown in the figures) that can be configured to move and/or cause movement thereof in a three-dimensional space (i.e. lateral translations along X, Y, Z axes and/or rotation about the X and/or Z axis, i.e. an optical axis of the laser source, as depicted in FIG. 1 and/or mechanical tilt). The movement mechanism can be any mechanism that is capable of performing high precision movements, such as but not limited to, a Microelectromechanical system (MEMS) (e.g. a quasi-static MEMS or a resonant MEMS, a single-axis MEMS or a dual-axis MEMS, etc.), a piezo-electric actuator, an electro-mechanical actuator, a linear voice coil actuator, etc.

In some cases, the multi-directional projector 100 can further comprise a repositioning component (e.g. a spring, a rubber element, etc.) that is configured to cause the reflective surface 112 to return to a known position upon deactivation of the movement mechanism (e.g. a starting position as depicted in FIG. 1).

The reflective surface 112 can be any surface (e.g. electromagnetically driven mirror) capable of reflecting the laser beams 114 emitted by the laser source 110 once it was moved and/or tilted, by the movement mechanism, to a predetermined position with respect to the laser 110. Such configuration enables the reflective surface 112 to reflect the incident laser beams 114 to a plurality of directions i.e. optical paths 116(1), 116(2), 116(3), . . . , 116(i) as depicted in FIG. 1, wherein (i) is an integer starting at 1.

The optical elements 118 can be phase elements that can be configured to manipulate an input laser beam to various output profiles and shapes (e.g. form a periodic projection pattern), such as but not limited to, pattern Diffractive Optical Elements (DOEs) and/or diffusers and/or Micro Lens Arrays (MLAs), etc. Each optical element 118 depicted in FIG. 1, can be configured to direct the incoming laser beams, reflected by the reflective surface 112 and traveled through a respective optical paths 116(1), 116(2), 116(3), . . . , 116(i), to a respective projection direction 124 with respect to the laser source 110.

It is to be noted that at least two of the optical elements 118 can be configured to direct the respective incoming laser beams in different projection directions so that at least part of a field of illumination of one of the given optical elements 118 covers an area located more than 90 degrees with respect to a projection direction of a center of projection of one of the given optical elements 118. For example, one DOE is configured to project along a positive Z axis so that the center of projection thereof is aligned with the positive Z axis whereas a second DOE is positioned so that its center of projection has an angle of 45 degrees with respect to the positive Z axis which yields field of illumination of the second DOE that part of it covers area that is located more than 90 degrees with respect to the center of projection of the first DOE (i.e. positive Z axis).

In some cases, at least two of the optical elements 118 can be configured to direct the respective incoming laser beams in different projection directions having a 180 degrees difference between the centers of the projection directions (as can be seen in FIG. 1 wherein two of the optical elements 118 have projection directions 124 along positive Z axis and two of the optical elements 118 have projection directions 124 along negative Z axis, i.e. there is a 180 degrees difference between the centers of the projection directions),In some cases, each of the optical elements 118 can be configured to cause scattering of the respective incoming laser beams, so that the scattering caused by a first optical element of the optical elements 118 at least partially overlaps the scattering caused by a second optical element of the optical elements 118. In such cases, the projector 100 can safely project a powerful laser beam into an overlapping Field of view (FOV) while meeting laser safety requirements that mandate maximum permissible exposure values.

The optical elements 118 can be configured to project a periodic light pattern onto a scene, i.e. structured lighting known in the art. The periodic light pattern can be a dot pattern, a line pattern, a custom grid design pattern, a polygonal pattern or any other pattern that can be designed pursuant to specific requirements and/or needs.

In some cases, the multi-directional projector 100 can further comprise one or more prisms 120, designed to redirect/realign the laser beams, traveled through a respective optical paths 116(1), 116(2), 116(3), . . . , 116(i), perpendicularly to a respective optical element 118, as shown in FIG. 1, to compensate for any laser beam deformation that may be caused during traveling thereof along one of the optical paths once the laser beam exits the laser 110. These prisms 120 can be DOEs or any other optical means that can be configured to perform redirection of the laser beams as described herein.

In some cases, the multi-directional projector 100 can further comprise one or more lenses (not shown in the figures) each optionally positioned on an optical path 116(1), 116(2), 116(3), . . . , 116(i) of a respective laser beam directed at a respective optical element 118. The lenses can be for example collimating lenses, diversion lenses, etc.

In other cases, the multi-directional projector 100 can further comprise one or more lenses (not shown in the figures) that may be positioned merely on the optical path of the laser beams 114 emitted by the laser source 110 towards the reflective surface 112. The lenses can be for example collimating lenses, so that collimated laser beams can then be reflected by the reflective surface 112 and travel optical paths 116(1), 116(2), 116(3), . . . , 116(i) as detailed hereinabove.

In some cases, the multi-directional projector 100 can further comprise one or more reflective elements 122 (e.g. static mirrors), each optionally positioned on an optical path, e.g. 116(1), 116(i) of a respective laser beam redirecting the respective laser beam at a respective optical element 118. In some cases, the reflective elements 122 can be moved by an additional movement mechanism in a three-dimensional space (i.e. lateral translations along and/or rotation about X, Y, Z axes and/or mechanical tilt) in order to expand optical scanning angles of the multi-directional projector 100. In some cases, the reflective elements 122 can be reflective surfaces, mutatis mutandis, as reflective surface 112.

In some cases, the multi-directional projector 100 can further comprise a controller (not shown in the figures) configured to cause activation of the laser source 110 in synchronicity with positions (as described herein above) of the reflective surface 112 so that the laser beams 114 generated by the laser source 110 are reflected by the reflective surface 112 in a direction of the respective optical elements 118.

In some cases, the multi-directional projector 100 can further comprise a position sensor capable of determining the positions of the reflective surface 112 (e.g. a rotation angle degree about the X and/or Y and/or the Z axis). The laser source 110 can be activated in synchronicity based on these positions. For example, the laser source 110 can be activated once the position sensor indicates that the reflective surface 112 arrived at a required position.

It is to be noted that FIG. 1 depicts merely an exemplary configuration of multi-directional projector 100 while other configurations, utilizing fewer or greater number of elements (i.e. optical elements 118, lenses, prisms 120, reflective elements 122) are possible. In some configurations optical scanning of 360 degrees with respect to the optical axis of the laser 110 can be achieved.

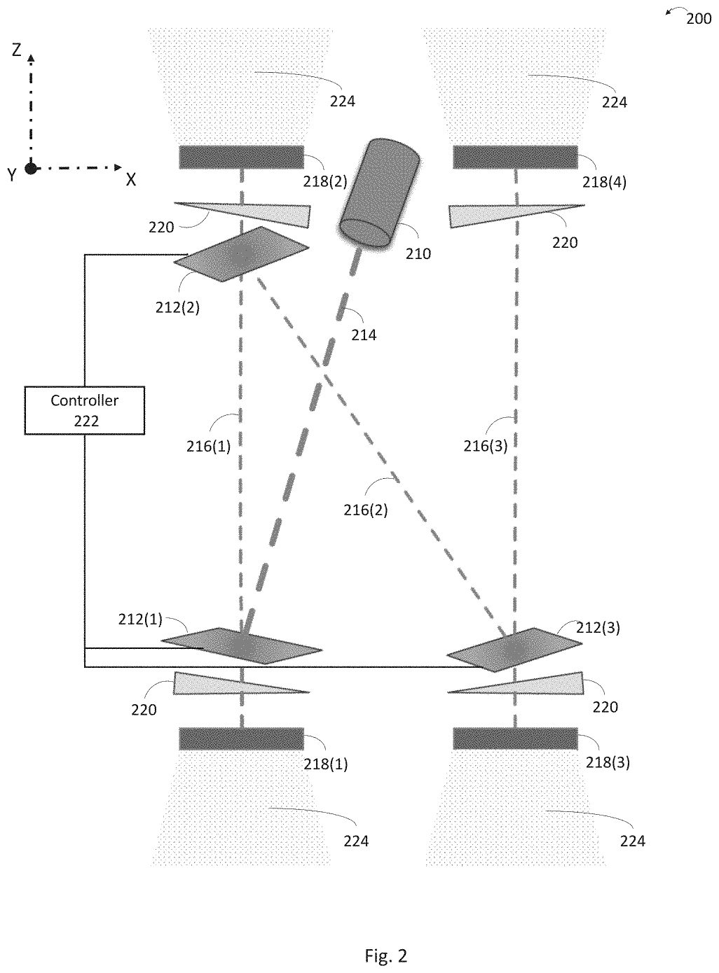

Turning to FIG. 2, showing a schematic illustration of another example of a multi-directional projector 200, in accordance with the presently disclosed subject matter.

The multi-directional projector 200 includes a laser source 210, one or more multi-mode optical path controlling elements 212, a controller 222 and a plurality of optical elements 218.

As shown in FIG. 2, the laser 210 (e.g. vertical-cavity surface-emitting laser (VCSEL), edge-emitting laser or the like) can be configured to emit laser beams 214 towards a multi-mode optical path controlling element 212(1). Each multi-mode optical path controlling element, i.e. 212(1), 212(2), . . . , 212(k), wherein (k) is an integer starting at 1, can have at least two operation modes including:
(a) a first operation mode in which the multi-mode optical path controlling element 212 reflects the laser beams directed thereon, i.e. laser beams that traveled via an optical path 214; and
   (b) a second operation mode in which the multi-mode optical path controlling element 214 enables passage of the laser beams directed thereon, i.e. laser beams that traveled via an optical path 214.

At least one of the multi-mode optical path controlling elements 212 can be an electrically switchable transflective mirror (i.e. electro-optically switchable mirror element known in the art) that can be based on a Liquid-crystal (LC), polymer dispersed liquid-crystal (PDLC) or formed of a thin layer of magnesium-titanium alloy film for example encapsulated between two layers of glass or can be based on any other (e.g. gasochromic) technology that can perform functions described herein.

In some cases, at least one of the multi-mode optical path controlling elements 212 can have a third operation mode in which the multi-mode optical path controlling element 212 enables passage of a first subset of the laser beams and reflection of a second subset of the laser beams, other than the first subset. This is in fact a semi-transparent operation mode wherein one portion of the incident laser beams passes through the multi-mode optical path controlling elements 212 while a second portion of the incident laser beams is reflected by the multi-mode optical path controlling elements 212.

In some cases, the third operation mode can be a selective mode enabling selectively determining a proportion between the first subset and the second subset. That is, the passage/reflectance degree of the laser beams through/by the multi-mode optical path controlling elements 212 can be modulated giving rise to varying portions of laser beams that can pass through the multi-mode optical path controlling elements 212 and laser beams that can be reflected by the multi-mode optical path controlling elements 212. For multi-mode optical path controlling elements 212 that are based on PDLC for example, liquid crystal droplets comprised therein are capable of changing their arrangement in response to a change in a level of voltage applied to the PDLC, so that the multi-mode optical path controlling element 212 becomes more transparent as the voltage increases, thereby enabling larger portion of laser beams to pass therethrough

Referring back to in FIG. 2, the multi-directional projector 200 includes plurality of optical elements 218, each capable of directing incoming laser beams of the laser beams to a respective projection direction 224 with respect to the laser source 210, wherein the incoming laser beams can be:
(a) reflected by one or more of the multi-mode optical path controlling elements 212 operating in the first operation mode, or
(b) passed through one or more of the multi-mode optical path controlling elements 212 operating in the second operation mode.

For example, laser beams traveled via optical path 214 towards multi-mode optical path controlling element 212(1) can pass therethrough, if it is operating in the second operation mode, towards optical element 218(1). If the multi-mode optical path controlling element 212(1) is operating in the first operation mode, the laser beams traveled via optical path 214 will be reflected therefrom towards multi-mode optical path controlling element 212(2). The reflected laser beams traveled via optical path 216(1) towards multi-mode optical path controlling element 212(2) can pass therethrough, if it is operating in the second operation mode, towards optical element 218(2). If the multi-mode optical path controlling element 212(2) is operating in the first operation mode, the laser beams traveled via optical path 216(1) will be reflected therefrom towards multi-mode optical path controlling element 212(3). The reflected laser beams traveled via optical path 216(2) towards multi-mode optical path controlling element 212(3) can pass therethrough, if it is operating in the second operation mode, towards optical element 218(3). If the multi-mode optical path controlling element 212(3) is operating in the first operation mode, the laser beams traveled via optical path 216(2) will be reflected therefrom towards optical element 218(4).

Each multi-mode optical path controlling element 212 can be controlled by the controller 222 that is capable of selectively changing an optical path of the laser beams over time by changing the operation modes thereof.

In some cases, the controller 222 can be further configured to cause activation of the laser source 210 in synchronicity with a desired setup of the operational modes of the multi-mode optical path controlling elements 218. For example, the laser source 210 can be activated once all the multi-mode optical path controlling elements 212 are operating in the first operation mode.

The optical elements 218 can be phase elements that can be configured to manipulate an input laser beam to various output profiles and shapes (e.g. form a periodic projection pattern), such as but not limited to, pattern Diffractive Optical Elements (DOEs) and/or diffusers and/or Micro Lens Arrays (MLAs), etc. Each optical element 218 depicted in FIG. 2 can be configured to direct the incoming laser beams to a respective projection direction 24 with respect to the laser source 210.

In some cases, each of the optical elements 218 can be configured to cause scattering of the respective incoming laser beams, so that the scattering caused by a first optical element of the optical elements 218 at least partially overlaps the scattering caused by a second optical element of the optical elements 218. In such cases, the projector 200 can safely project a powerful laser beam into an overlapping Field of view (FOV) while meeting laser safety requirements that mandate maximum permissible exposure values.

The optical elements 218 can be configured to project a periodic light pattern onto a scene, i.e. structured lighting known in the art. The light pattern can be a dot pattern, a line pattern, a custom grid design pattern, a polygonal pattern or any other pattern that can be designed pursuant to specific requirements and/or needs.

In some cases, the multi-directional projector 200 can further comprise one or more prisms 220, designed to redirect/realign the laser beams, passed through and/or reflected from multi-mode optical path controlling element 212, perpendicularly to a respective optical element 218, as shown in FIG. 2, to compensate for any laser beam deformation that may be caused during traveling thereof along one of the optical paths once the laser beam exits the laser 210. These prisms 220 can be DOEs or any other optical means that can be configured to perform redirection of the laser beams as described herein.

In some cases, the multi-directional projector 200 can further comprise one or more lenses (not shown in the figures) each optionally positioned on an optical path 214, 216(1), 216(2), 216(3) of a respective laser beam directed at a respective optical element 118. The lenses can be positioned before the multi-mode optical path controlling element 212 or after (e.g. between the multi-mode optical path controlling element 212 and a respective prism 220 or between the prism 220 and a respective optical element 218). The lenses can be for example collimating lenses, diversion lenses, etc.

In other cases, the multi-directional projector 200 can further comprise one or more lenses (not shown in the figures) that may be positioned merely on the optical path of the laser beams 214 emitted by the laser source 210 towards the first multi-mode optical path controlling element 212(1). The lenses can be for example collimating lenses, so that collimated laser beams can then be reflected by the multi-mode optical path controlling element 212(1) or passed therethrough as detailed hereinabove.

In some cases, the multi-directional projector 200 can further comprise one or reflective elements (not shown in the figures), e.g. static mirrors, each optionally positioned on an optical path, e.g. 214, 216(1), 216(2), 216(3), of a respective laser beam redirecting the respective laser beam at a respective optical element 218. For example, reflective element can be positioned on optical path 216(3) to redirect laser beams reflected by multi-mode optical path controlling element 212(3) optionally towards additional multi-mode optical path controlling element or optical element 218 (not shown in the figures). In some cases, the reflective elements can be moved by a movement mechanism in a three-dimensional space (i.e. lateral translations along and/or rotation about X, Y, Z axes and/or mechanical tilt) in order to expand optical scanning angles of the multi-directional projector 200. The movement mechanism can be any mechanism that is capable of performing high precision movements, such as but not limited to, a Microelectromechanical system (MEMS) (e.g. a quasi-static MEMS or a resonant MEMS, a single-axis MEMS or a dual-axis MEMS, etc.), a piezo-electric actuator, an electro-mechanical actuator, a linear voice coil actuator, etc.

It is to be noted that FIG. 2 depicts merely an exemplary configuration of multi-directional projector 200 while other configurations, utilizing fewer or greater number of elements (i.e. multi-mode optical path controlling elements 212, optical elements 218, lenses, prisms 220, reflective elements), are possible. In some configurations optical scanning of 360 degrees with respect to the optical axis of the laser 210 can be achieved.

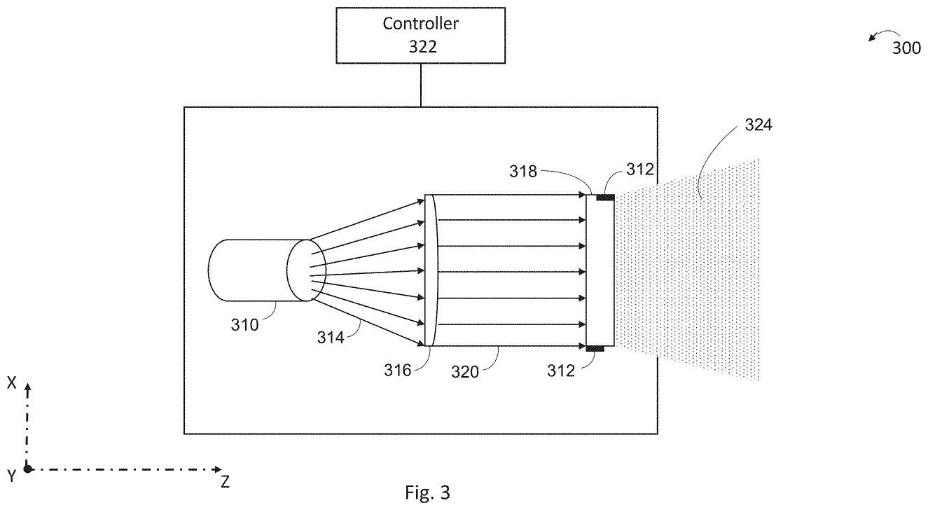

Turning to FIG. 3, showing a schematic illustration of one example of a hyper-resolution pattern projector 300, in accordance with the presently disclosed subject matter.

The hyper-resolution pattern projector 300 includes a laser source 310, a movement mechanism 312, a collimating lens 316, a Diffractive Optical Element (DOE) 318 and a controller 322.

As shown in FIG. 3, the laser 310 (e.g. vertical-cavity surface-emitting laser (VCSEL), edge-emitting laser or the like) can be configured to emit laser beams 314 optionally towards collimating lens 316, wherein collimated laser beams 320 that exit the collimating lens 316 incident the Diffractive Optical Element (DOE) 318. The diffractive Optical Element (DOE) 318 can be configured to project the laser beams, directly or indirectly (e.g. by utilizing additional lenses and/or DOEs or the like), in a fixed pattern 324 onto a scene. The diffractive optical element (DOE) 318 shape and split incoming laser beams in an energy-efficient manner and output a desired light pattern for projection onto a scene. The light pattern can be a periodic dot pattern, a line pattern, a custom grid design pattern, a polygonal pattern or any other pattern that can be designed pursuant to specific requirements and/or needs.

In some cases, instead of DOE a Micro Lens Array (MLA) can be used.

According to currently disclosed subject matter, the movement mechanism 312 can be configured to rotate the DOE about Z axis and/or tilt the DOE in order to provide additional optical scanning angles of the scene. The movement mechanism 312 can be any mechanism that is capable of performing high precision movements, such as but not limited to, a Microelectromechanical system (MEMS) (e.g. a quasi-static MEMS or a resonant MEMS, a single-axis MEMS or a dual-axis MEMS, etc.), a piezo-electric actuator, an electro-mechanical actuator, a linear voice coil actuator, etc.

The hyper-resolution pattern projector 300 can also include a controller 322 that can be configured to activate the laser source 310 to emit a first set of the laser beams and thereby project a first pattern that can be the fixed pattern onto first locations on the scene. Upon projection of the first fixed pattern, the controller 322 can activate the movement mechanism 312 to rotate and/or tilt the DOE 318 and reactivate the laser source 310 to emit a second set of the laser beams and thereby project a second pattern that can be the fixed pattern onto second locations on the scene, wherein the first pattern and the second pattern are identical. It is to be noted that in some cases more than two patterns can be projected by the hyper-resolution pattern projector 300 onto more than two locations on the scene thereby providing a hyper-resolution pattern as presently disclosed herein. In some cases, a portion of each of the projected patterns can overlap with another projected patterns.

In some cases, the hyper-resolution pattern projector 300 can further comprise a repositioning component (e.g. a spring, a rubber element, etc.) that is configured to cause the DOE 318 to return to a known position upon deactivation of the movement mechanism 312 (e.g. a starting position as depicted in FIG. 3).

In some cases, the hyper-resolution pattern projector 300 can further comprise a position sensor capable of determining the positions of the DOE 318 (e.g. a rotation angle degree about the X and/or Y axis and/or the Z axis). The reactivation of the laser source 310 can be performed based on a position reading of the DOE 318 obtained from the position sensor. For example, the laser source 310 can be reactivated once the position sensor indicates that the DOE 318 arrived at a required position.

In some cases, the hyper-resolution pattern projector 300 can further comprise one or more lenses (not shown in the figures) each optionally positioned on an optical path of the laser beams 314 directed at the DOE 318. The lenses can be positioned before the DOE 318 or after. The lenses can be for example collimating lenses, diversion lenses, etc.

It is to be noted that FIG. 3 depicts merely an exemplary configuration of hyper-resolution pattern projector 300 while other configurations, utilizing fewer or greater number of elements (i.e. movement mechanisms, DOEs 318, lenses, controllers), are possible.

According to currently disclosed subject matter, a system can include the hyper-resolution pattern projector 300, an image acquisition device and a processing circuitry.

The image acquisition device can be at least one two-dimensional or stereo camera that can be configured to acquire images of the scene, i.e. images of the fixed one or more patterns projected by the hyper-resolution pattern projector 300 onto the scene, as described hereinabove with respect to FIG. 3.

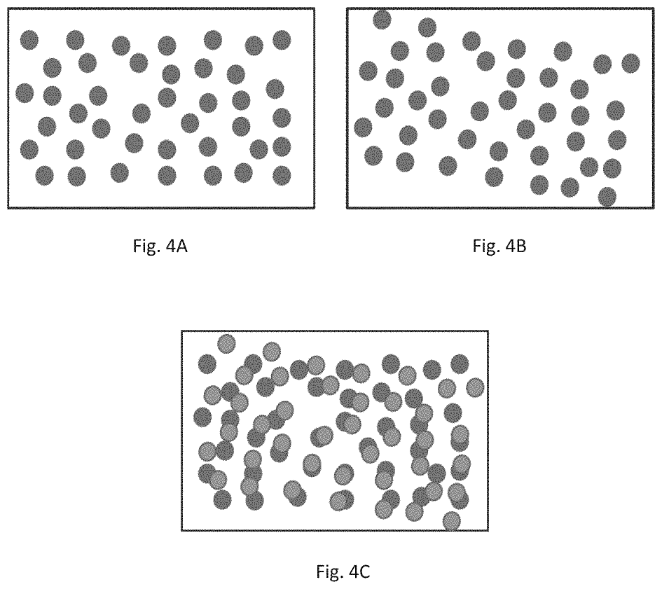

Reference is currently made to FIGS. 4A-4C that depict schematic illustration of one example of projected patterns in accordance with the presently disclosed subject matter.

FIG. 4A illustrates an exemplary first pattern that can be the fixed pattern that can be projected onto first locations on the scene.

FIG. 4B illustrates an exemplary second pattern that can be the fixed pattern that can be projected onto second locations on the scene.

FIG. 4C illustrates an exemplary superimposed hyper resolution pattern.
The processing circuitry can be configured to activate the image acquisition device to acquire images of the first pattern and the second pattern (e.g. patterns illustrated in FIGS. 4A and 4B), generate a hyper resolution pattern image comprising the first pattern and the second pattern (e.g. pattern illustrated in FIG. 4C) and analyze the hyper resolution pattern image to determine a location of at least one object within the scene.

The hyper resolution pattern image can be attained by projecting the fixed pattern onto second locations on the scene, once the DOE 318 is rotated and/or tilted by the movement mechanism 312, thereby providing additional light dots for example (in case where a dot pattern is utilized) in the scene that can be captured by the image acquisition device. The tilt movement of the DOE 318 is advantageous as it can shift of a group of light dots in the scene (e.g. dots that are located at the center of the projected pattern) that otherwise were not be moved to shifted locations, during projection of the fixed pattern onto second locations on the scene, if the DOE 318 was merely rotated about Z axis.

Although the foregoing disclosed subject matter exemplifies projection of fixed pattern onto two locations in the scene, it is to be noted that the hyper-resolution pattern projector 300 can be configured to project the fixed pattern onto any number of locations as needed.

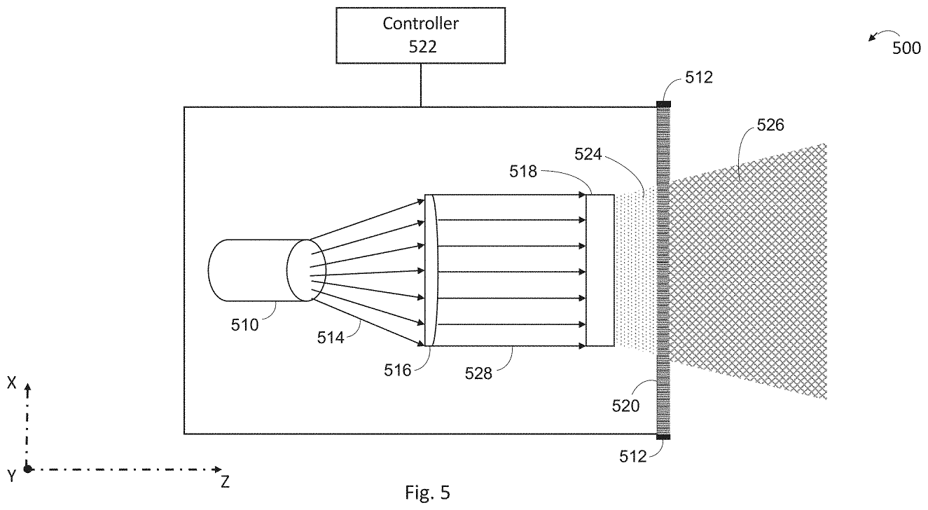

Turning to FIG. 5, showing a schematic illustration of another example of a hyper-resolution pattern projector 500, in accordance with the presently disclosed subject matter.

The hyper-resolution pattern projector 500 includes a laser source 510, a movement mechanism 512, a collimating lens 516, an optical element 518, a mask 520 and a controller 522.

As shown in FIG. 5, the laser 510 (e.g. vertical-cavity surface-emitting laser (VCSEL), edge-emitting laser or the like) can be configured to emit laser beams 514 optionally towards collimating lens 516, wherein collimated laser beams 528 that exit the collimating lens 516 incident the optical element 518. The optical element 518 can be configured to project the laser beams, directly or indirectly (e.g. by utilizing additional lenses and/or optical elements or the like), in a fixed pattern 524. The optical element 518 can be a diffractive Optical Element (DOE) that can be configured to shape and split incoming laser beams in an energy-efficient manner and output a desired light pattern. The light pattern can be a periodic dot pattern, a line pattern, a custom grid design pattern, a polygonal pattern or any other pattern that can be designed pursuant to specific requirements and/or needs.

In some cases, the optical element 518 can be a Micro Lens Array (MLA).

The fixed pattern 524 emitted by the optical element 518 incidents the mask 520 that can be configured to block at least part of the pattern 524 and thereby allow a portion thereof 526 to be projected onto the scene (i.e. the mask 520 can project a sub-pattern 526 of the fixed pattern onto a scene). The mask 520 can be any optical element that can be configured to allow light to selectively pass therethrough (e.g. the mask can be made of a Polymer plastic material having physical barriers to block selectively portions of light passing therethrough).

The movement mechanism 512 can be configured to move the mask 520 in at least one degree of freedom (e.g. tilting, rotating, translating, or any combination thereof). The movement mechanism 312 can be any mechanism that is capable of performing high precision movements, such as but not limited to, a Microelectromechanical system (MEMS) (e.g. a quasi-static MEMS or a resonant MEMS, a single-axis MEMS or a dual-axis MEMS, etc.), a piezo-electric actuator, an electro-mechanical actuator, a linear voice coil actuator, etc.

The hyper-resolution pattern projector 500 can also include a controller 522 that can be configured to activate the laser source 510 to emit a first set of the laser beams and thereby project a first sub-pattern of the fixed pattern onto the scene. Upon projection of the first sub-pattern, the controller 522 can activate the movement mechanism 512 to move the mask 520 and reactivate the laser source 510 to emit a second set of the laser beams and thereby project a second sub-pattern of the fixed pattern onto the scene, wherein the first sub-pattern and the second sub-pattern are not identical. The fixed pattern emitted by the optical element 518 can be homogeneous (i.e. having a non-arbitrary illumination pattern) while the first sub-pattern and the second sub-pattern emitted by the mask 520 can be non-homogeneous (i.e. having arbitrary illumination patterns).

In some cases, the mask 520 can be designed to redirect the laser beams directed at the blocked part of the pattern to a non-blocked part of the pattern thereby optimize utilization of the laser beams generated by the laser 510.

In some cases, the hyper-resolution pattern projector 500 can further comprise a repositioning component (e.g. a spring, a rubber element, etc.) that is configured to cause the mask 520 to return to a known position upon deactivation of the movement mechanism 512 (e.g. a starting position as depicted in FIG. 5).

In some cases, the hyper-resolution pattern projector 500 can further comprise a position sensor capable of determining the positions of the mask 520 (e.g. lateral translations in X-Y plane). The reactivation of the laser source 310 can be performed based on a position reading of the mask 520 obtained from the position sensor. For example, the laser source 510 can be activated once the position sensor indicates that the mask 520 arrived at a required position.

In some cases, the hyper-resolution pattern projector 500 can further comprise one or more lenses (not shown in the figures) each optionally positioned on an optical path of the laser beams 514 directed at the optical element 518. The lenses can be positioned before the optical element 518 or after. The lenses can be for example collimating lenses, diversion lenses, etc.

In some cases, the mask 520 of the hyper-resolution pattern projector 500 can be positioned before the optical element 518, mutatis mutandis.

It is to be noted that FIG. 5 depicts merely an exemplary configuration of hyper-resolution pattern projector 500 while other configurations, utilizing fewer or greater number of elements (i.e. movement mechanisms, optical elements 518, lenses, controllers), are possible.

According to currently disclosed subject matter, a system can include the hyper-resolution pattern projector 500, an image acquisition device and a processing circuitry.

The image acquisition device can be at least one two-dimensional or stereo camera that can be configured to acquire images of the scene, i.e. images of the one or more sub-patterns projected by the hyper-resolution pattern projector 500 onto the scene, as described hereinabove with respect to FIG. 5.

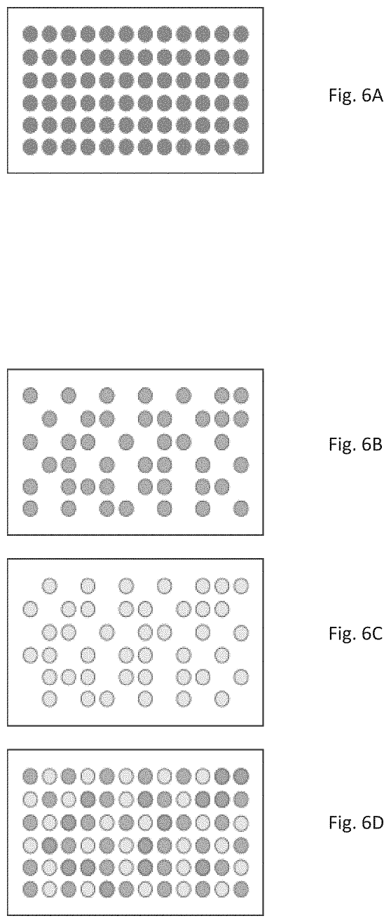

Reference is currently made to FIGS. 6A-6D that depict schematic illustration of another example of projected patterns in accordance with the presently disclosed subject matter.

FIG. 6A illustrates an exemplary projection pattern that can be the fixed pattern that can be projected by the optical elements 518.

FIG. 6B illustrates an exemplary first sub-pattern of the fixed pattern that can be projected onto the scene.

FIG. 6C illustrates an exemplary second sub-pattern of the fixed pattern that can be projected onto the scene.

FIG. 6D illustrates an exemplary superimposed hyper resolution pattern.

The processing circuitry can be configured to activate the image acquisition device to acquire images of the first sub-pattern and the second sub-pattern (e.g. patterns illustrated in FIGS. 6B and 6C), generate a hyper resolution pattern image comprising the first sub-pattern and the second sub-pattern (e.g. pattern illustrated in FIG. 6D) and analyze the hyper resolution pattern image to determine a location of at least one object within the scene.

The hyper resolution pattern image can be attained by projecting the first sub-pattern onto the scene while the mask 520 is blocking first portion of the fixed pattern 524 generated by the optical element 518. Next, the mask 520 is mechanically translated in the X-Y plane and/or rotated about the Z axis by the movement mechanism 512, then the second sub-pattern is projected onto the scene while the mask 520 is blocking second portion of the fixed pattern 524 generated by the optical element 518. This way, the hyper-resolution pattern projector 500 can provide maximum energy per dot (in case where a dot pattern is utilized) while meeting laser safety requirements that mandate maximum permissible exposure values.

Although the foregoing disclosed subject matter exemplifies projection of merely first sub-pattern and second sub-pattern onto the scene, it is to be noted that the hyper-resolution pattern projector 500 can be configured to project any number of sub-patterns as needed onto the scene.

It is to be understood that the presently disclosed subject matter is not limited in its application to the details set forth in the description contained herein or illustrated in the drawings. The presently disclosed subject matter is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the present presently disclosed subject matter.

It will also be understood that the system according to the presently disclosed subject matter can be implemented, at least partly, as a suitably programmed computer. Likewise, the presently disclosed subject matter contemplates a computer program being readable by a computer for executing the disclosed method. The presently disclosed subject matter further contemplates a machine-readable memory tangibly embodying a program of instructions executable by the machine for executing the disclosed method.

Examples of the presently disclosed subject matter may be provided as a computer program product, or software, that may include a machine-readable medium having stored thereon instructions, which may be used to program a computer system (or other electronic devices) to perform a process according to the presently disclosed subject matter. A machine-readable medium includes any mechanism for storing or transmitting information in a form readable by a machine (e.g. a computer). For example, a machine-readable (e.g. computer readable) medium includes a machine (e.g. a computer) readable storage medium (e.g. read only memory (“ROM”), random access memory (“RAM”), magnetic disk storage media, optical storage media, flash memory devices, etc.), a machine (e.g. computer) readable transmission medium (electrical, optical, acoustical or other form of propagated signals (e.g., infrared signals, digital signals, etc.)), etc.

FIG. 1 illustrates a diagrammatic representation of a system in the exemplary form of a machine including hardware and software such as e.g. set of instructions, causing the system to perform any one or more of the above techniques. In alternative examples, the machine may be connected (e.g. networked) to other machines in a Local Area Network (LAN), an intranet, an extranet, or the Internet. Further, while only a single machine is illustrated, the term “machine” shall also be taken to include any collection of machines (e.g. computers) that individually or jointly execute a set (or multiple sets) of instructions to perform any one or more of the methodologies discussed herein.

In the foregoing specification, the presently disclosed subject matter has been described with reference to specific examples of embodiments of the presently disclosed subject matter. It will, however, be evident that various modifications and changes may be made therein without departing from the broader spirit and scope of the presently disclosed subject matter as set forth in the appended claims.

Also, the presently disclosed subject matter is not limited to physical devices or units implemented in nonprogrammable hardware but can also be applied in programmable devices or units able to perform the desired device functions by operating in accordance with suitable program code, such as mainframes, minicomputers, servers, workstations, personal computers, notepads, personal digital assistants, electronic games, and other embedded systems, cell phones and various other wireless devices, commonly denoted in this application as ‘computer systems’.

However, other modifications, variations and alternatives are also possible. The specifications and drawings are, accordingly, to be regarded in an illustrative rather than in a restrictive sense.

While certain features of the presently disclosed subject matter have been illustrated and described herein, many modifications, substitutions, changes, and equivalents will now occur to those of ordinary skill in the art. It is, therefore, to be understood that the appended claims are intended to cover all such modifications and changes as fall within the true spirit of the presently disclosed subject matter.

1-15. (canceled)

16. A multi-directional projector comprising:
a laser source capable of emitting laser beams; one or more multi-mode optical path controlling elements, each having at least two operation modes including (a) a first operation mode in which the multi-mode optical path controlling element reflects the laser beams directed thereon, and (b) a second operation mode in which the multi-mode optical path controlling element enables passage of the laser beams directed thereon;
a plurality of optical elements, each capable of directing incoming laser beams of the laser beams to a respective projection direction with respect to the laser source, wherein the incoming laser beams are (a) reflected by one or more of the multi-mode optical path controlling elements operating in the first operation mode, or (b) passed through one or more of the multi-mode optical path controlling elements operating in the second operation mode; and
a controller capable of selectively changing an optical path of the laser beams over time by changing the operation modes of one or more of the multi-mode optical path controlling elements.

17. The multi-directional projector of claim 16, wherein at least one of the multi-mode optical path controlling elements has a third operation mode in which the multi-mode optical path controlling element enables passage of a first subset of the laser beams and reflection of a second subset of the laser beams, other than the first subset.

18. The multi-directional projector of claim 17, wherein the third operation mode is a selective mode enabling selectively determining a proportion between the first subset and the second subset.

19. The multi-directional projector of claim 16, wherein at least one of the multi-mode optical path controlling elements is a switchable mirror element.

20. The multi-directional projector of claim 16, wherein the optical elements are pattern Diffractive Optical Elements (DOEs) and/or diffusers and/or Micro Lens Arrays (MLAs).

21. The multi-directional projector of claim 20, wherein a pattern of the pattern DOEs is selected from a group of: a dot pattern, a line pattern, or a polygonal pattern.

22. The multi-directional projector of claim 16, further comprising one or more prisms, designed to redirect the laser beam perpendicularly to a respective optical element.

23. The multi-directional projector of claim 16, further comprising one or more lenses, each positioned on an optical path of a respective laser beam directed at a respective optical element.

24. The multi-directional projector of claim 16, wherein each of the optical elements cause scattering of the respective incoming laser beams, so that the scattering caused by a first optical element of the optical elements at least partially overlaps the scattering caused by a second optical element of the optical elements.

25. The multi-directional projector of claim 16, further comprising one or more reflective elements, each positioned on the optical path of a respective laser beam redirecting the respective laser beam at a respective optical element.

26. The multi-directional projector of claim 16, wherein the controller is further configured to cause activation of the laser source in synchronicity with a desired setup of the operational modes of the multi-mode optical path controlling elements.

27-44. (canceled)
